(19) United States
(12) Patent Application Publication
(10) Pub. No.: US 2004/0088895 A1
(43) Pub. Date: May 13, 2004

(54) Lighting fixture and luminous sign

(75) Inventor: Jari Tabell, Lahti (FI)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Teknoware Oy, Lahti (FI)

(21) Appl. No.: 10/701,973

(22) Filed: Nov. 5, 2003

(30) Foreign Application Priority Data
Nov. 5, 2002 (FI) 20021979

(51) Int. Cl. G09F 13/04

(52) U.S. Cl. 40/547; 40/570

(57) ABSTRACT

A lighting fixture, in particular an exit sign luminaire or a similar instructive luminaire, which comprises a mounting housing (1) that is arranged to receive power supply (7) for a light source (5) of the luminaire and that is arranged for securing to a mounting base, such as a wall or a ceiling, and a sign part (2) that is arranged for securing in connection with the mounting housing (1). The mounting housing (1) is arranged to receive the light source (5) and the lighting fixture also comprises at least one optical fiber (6) arranged to transmit light, the first end (9) of which optical fiber is arranged in connection with the light source (5) in the mounting housing (1) and whose light-transmitting portion (8) is arranged in connection with the sign part (2) so as to illuminate it with light produced by the light source (5).

### BACKGROUND OF THE INVENTION

The present invention relates to a lighting fixture, in particular to an exit sign luminaire or other instructive luminaire, which comprises a mounting housing that is arranged to receive power supply for a light source of the luminaire and that is arranged for securing to a mounting base, such as a wall or a ceiling, and a sign part that is arranged for securing in connection with the mounting housing.

Exit sign luminaires are typically used in buildings or other constructions, such as ships, to direct people to an exit point. The exit sign luminaires should fulfil given requirements for illumination and disposition.

Currently the exit sign luminaires and other illuminated signs are often implemented such that the lighting fixture comprises two separate parts to be interconnected, i.e. a mounting housing and a luminous sign. The mounting housing is typically secured to a wall or ceiling in connection with electrotechnical installations. The mounting housing includes the necessary connectors for switching supply voltage to the lighting fixture and optionally electronic circuits necessary for the lighting fixture.

The luminous sign, in turn, serves as the actual illuminator and it includes a light source and optionally electronic circuits associated with the operation of the light source.

This solution makes it possible that only the lighting fixture parts that are necessary for the securing and the electrotechnical installations are to be installed during the wiring of the building. The actual luminous signs will not be installed until the property or the like is otherwise completed, and thus the luminous signs will not be exposed to damage or soiling during the construction work.

The above-mentioned solution has a problem that voltage supply for the luminous sign must be provided from the mounting housing using a separate wire or connector. This poses a reliability risk, however, and often it is also difficult and expensive to implement as regards electrical safety. An electrician is also needed if electrical couplings are required for installing the luminous sign. So, electrotechnical work cannot be completed in one go during the construction.

### BRIEF DESCRIPTION OF THE INVENTION

It is the object of the present invention to provide a lighting fixture that avoids the above-mentioned drawbacks and enables the lighting fixture to be implemented in a simpler and more cost-effective manner than previously. This is achieved with a lighting fixture according to the invention, which is characterized in that a mounting housing is arranged to receive a light source and that the lighting fixture also comprises at least one optical fiber arranged to transmit light, a first end of which optical fiber is arranged in connection with the light source in the mounting housing and whose light-transmitting portion is arranged in connection with a sign part so as to illuminate it with light emitted by the light source.

The preferred embodiments of the invention are disclosed in the dependent claims.

The invention is based on the idea that the lighting fixture is implemented by disposing electrical parts in a mounting housing and by transferring light produced in the mounting housing via an optical fiber to an object to be illuminated, i.e. a luminous sign. Thus, electricity is not brought to the actual luminous sign part at all. The structure according to the invention makes it possible that electric couplings need not be done and live parts need not be handled while luminous signs are installed. Thus the lighting fixture of the invention contributes to improved work safety during construction and installation stages.

The invention also relates to a luminous sign that is arranged for use in a lighting fixture, such as an exit sign luminaire or other instructive luminaire. The luminous sign is characterized by comprising one or more cavities leading inside the luminous sign that are arranged to receive an optical fiber for illuminating the luminous sign. Using a luminous sign of this kind it is possible to achieve the advantages provided by the lighting fixture of the invention with a simple structure.

### BRIEF DESCRIPTION OF THE DRAWINGS

In the following the invention will be described in connection with preferred embodiments, with reference to the attached drawings, wherein

FIG. 1 shows a structural principle of a lighting fixture of the invention; and

FIG. 2 shows a perspective view of a preferred embodiment of the lighting fixture of the invention.

### DETAILED DESCRIPTION OF THE INVENTION

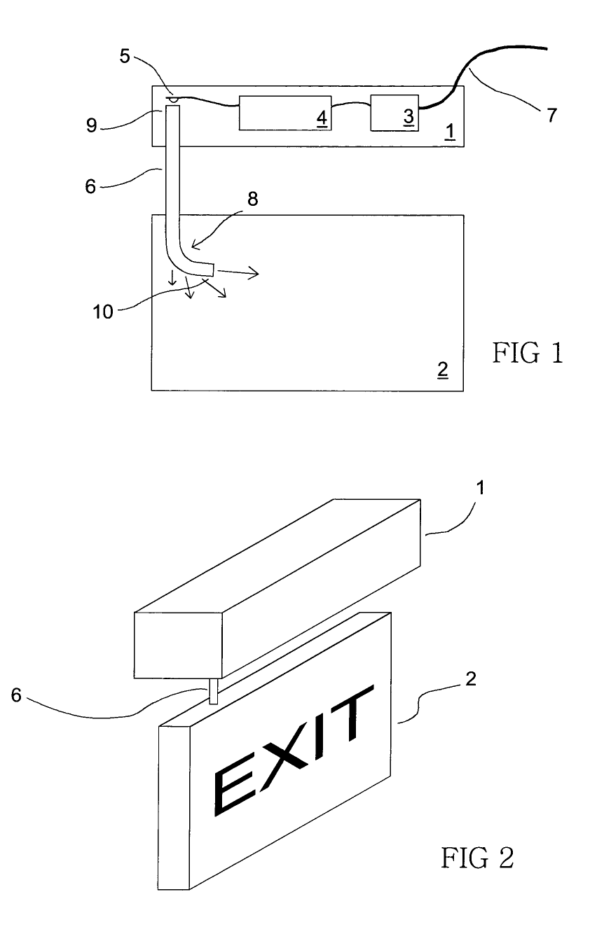

FIG. 1 shows a cross-sectional view of the structure of a lighting fixture according to the invention in principle. The lighting fixture has a mounting housing 1, through which the lighting fixture is secured to the ceiling or a similar place. The mounting housing of the lighting fixture according to the invention holds all electric components associated with the operation of the lighting fixture. In the structure of FIG. 1, the mounting housing comprises a coupling box 3, to which voltage feeding the lighting fixture is connected with a feed line 7.

From the coupling box the supply voltage is conducted to a connection device 4, which produces suitable voltage or current to the light source 5 located in the mounting housing for burning it. In connection with the invention, the connection device can be any component that enables the operation of the light source type used. In the lighting fixture of the invention it is also possible to use any illuminating element, such as a light emitting diode, a gas-discharge lamp or an incandescent lamp, as the light source. It is obvious that light sources 5 of various types may need different types of connection devices 4 to operate.

As it appears from the above, all electric parts of the lighting fixture according to the invention are located inside the mounting housing 1.

In accordance with the invention, the lighting fixture also comprises a sign part which contains the information intended for those who see the lighting fixture. The sign part is disposed in connection with the mounting housing and typically secured thereto.

The lighting fixture of the invention also comprises at least one optical fiber 6 which is arranged to transmit light and whose first end 9 is arranged in the mounting housing 1 in connection with the light source 5. Further, the light-transmitting portion 8 of the optical fiber in the lighting fixture is arranged in connection with the sign part so as to illuminate it with the light produced by the light source. Thus, the optical fiber transmits the light produced in the mounting housing to the sign part so as to illuminate it.

The optical fibers are optical conductors, to which light can be supplied from the optical fiber end. The optical fiber transmits the supplied light very efficiently within the fiber. According to a preferred embodiment of the invention, the light-transmitting portion 8 of the optical fiber comprises the second end of the optical fiber. In this embodiment light is produced for the sign part 2 only through the second end 10 of the optical fiber 6.

The sides of a typical optical fiber are not light-transmitting, but the optical fiber transmits the light up to the second end and out therefrom. However, the optical fiber can be treated such that its sides will pass light as well. According to one preferred embodiment of the invention the light-transmitting portion 8 of the optical fiber includes a side portion that is arranged to pass light. Thus a larger portion of the sign part can be illuminated with the optical fiber, because the produced light is distributed on a wider area in the sign part. Naturally, the optical fiber can pass light both at the end and on the sides so as to provide the best possible illumination.

According to one preferred embodiment of the invention the sign part 2 is at least partly of light-transmitting material, and the light-transmitting portion of the optical fiber is disposed inside the sign part. The sign can be simply designed such that it is illuminated in two directions, illumination being carried out from within the sign part. FIGS. 1 and 2 show an embodiment of the lighting fixture according to the invention, in which the sign part 2 is a luminous sign. This luminous sign of the invention is made of multi-layer material such that the pattern of the sign is formed of one or more layers. Typically the luminous sign is at least partly closed, fully transparent and only the instructive information contained therein is formed of substantially non-transparent material.

It is also possible to make the sign part to be a box-like, openable structure. In the box-like structure, walls of the sign part are made of thin, non-transparent material that includes a pattern. The wall material transmits light in a different manner at the pattern area, whereby the pattern of the lighting fixture will be appropriately distinguishable.

According to one preferred embodiment of the invention the sign part is arranged to be secured to the mounting housing at least partly through one or more optical fibers as shown in FIG. 2. Optical fibers can be manufactured in various thicknesses, the thickest fibers being relatively rigid. In addition, the optical fibers are of substantially hard material, which enables the use of the optical fiber for securing the sign part. The securing can be carried out by means gripping the optical fiber, the means being secured both to the mounting housing and to the sign part. These means allow the fiber to be gripped in a reliable manner, without damaging the fiber itself, however. A reinforcement tube can also be arranged around the fiber between the mounting housing and the sign part, the tube at least substantially enveloping the optical fiber. By means of this reinforcement tube the sign part can be secured to the mounting housing in a further more reliable manner.

Further in accordance with the invention, a plurality of optical fibers, by which the light produced in the mounting housing is transmitted to the sign part, can be applied to the sign part. In that case the sign part can be secured using all optical fibers.

When the sign part is a luminous sign, the luminous sign should be provided with a cavity, in which the optical fiber can be inserted sufficiently deep. The cavity for the optical fiber may have almost any shape in view of the maximum bending radius of the fiber. This provides a wide variety of alternatives for the luminous sign design, because the surface of the fiber can be treated such that it is illuminating in desired areas. It is also possible to implement the lighting fixture of the invention by using one optical fiber such that both ends of the fiber are applied to the mounting housing and both ends are arranged in connection with the light source. In that case light is supplied from both ends to the optical fiber and the portion of the optical fiber inside the luminous sign is treated to illuminate the luminous sign. Naturally, the mounting housing may contain a plurality of light sources, if necessary.

The ceiling material used in many installation applications is a lining, above which the electric wiring is laid. In connection with the wiring and the electric installations the mounting housing of the lighting fixture according to the invention is connected to the mains supply. This supply box can be disposed above the ceiling lining and only the sign part, to which light is transmitted along the optical fiber, is left below the ceiling lining. Another option is to secure the mounting housing in a standard manner so that it is visible in the ceiling and further secure the sign part to the mounting housing in the above-described manner.

It is obvious to a person skilled in the art that as technology advances the basic idea of the invention can be implemented in a variety of ways. The invention and its embodiments are thus not restricted to the above-described examples, but they may vary within the scope of the claims.

1. A lighting fixture, in particular to an exit sign luminaire or other instructive luminaire, which comprises
a mounting housing that is arranged to receive a light source of the luminaire and a power supply for the light source and the mounting housing is further arranged to be secured to a mounting base, such as a wall or a ceiling, and
a sign part that is arranged for securing in connection with the mounting housing, wherein the
the lighting fixture further comprises at least one optical fiber arranged to transmit light, a first end of which optical fiber is arranged in connection with the light source in the mounting housing and whose light-transmitting portion is arranged in connection with the sign part so as to illuminate it with light emitted by the light source.

2. The lighting fixture of claim 1, wherein the light-transmitting portion of the optical fiber comprises the second end of the optical fiber.

3. The lighting fixture of claim 1, wherein the light-transmitting portion of the optical fiber comprises an optical fiber portion that is arranged to pass light through its side.

4. The lighting fixture of claim 1, 2 or 3, wherein the sign part is at least partly of light-transmitting material and that the light-transmitting portion of the optical fiber is disposed inside the sign part.

5. The lighting fixture of claim 1, wherein the light-transmitting portion of the optical fiber comprises the second end of the optical fiber and a portion substantially in the vicinity of the second end of the optical fiber.

6. The lighting fixture of claim 1, 2, 3 or 5, wherein the sign part is a plate that is at least partly closed.

7. The lighting fixture of claim 1, wherein the sign part is arranged to be secured to the mounting housing at least partly through one or more optical fibers.

8. The lighting fixture of claim 4, wherein the sign part is arranged to be secured to the mounting housing at least partly through one or more optical fibers.

9. The lighting fixture of claim 1, wherein the sign part is a luminous sign.

10. The lighting fixture of claim 4, wherein the sign part is a luminous sign.

11. A luminous sign that is arranged for use in a lighting fixture, such as an exit sign luminaire or other instructive luminaire, wherein the luminous sign comprises one or more cavities leading inside the luminous sign that are arranged to receive an optical fiber for illuminating the luminous sign.
